(19) United States
(12) Patent Application Publication
(10) Pub. No.: US 2016/0239494 A1
(43) Pub. Date: Aug. 18, 2016

(54) DETERMINING AND MAINTAINING A LIST OF NEWS STORIES FROM NEWS FEEDS MOST RELEVANT TO A TOPIC

(71) Applicant: ACQUIRE MEDIA VENTURES INC., Roseland, NJ (US)

(72) Inventors: Lawrence C. Rafsky, Livingston, NJ (US); Jonathan Alan Marshall, Montclair, NJ (US); Raymond Sun, East Brunswick, NJ (US)

(21) Appl. No.: 14/730,840

(22) Filed: Jun. 4, 2015

Related U.S. Application Data
(60) Provisional application No. 62/115,260, filed on Feb. 12, 2015.

(51) Int. Cl. G06F 17/30; H04L 29/08

(52) U.S. Cl. CPC G06F 17/3053; H04L 67/26; G06F 17/30864

(57) ABSTRACT

A server may receive a request from a client for a list of stories pertaining to a topic or the server may initiate pushing to the client the list of stories pertaining to the topic. The server obtains a first list of stories pertaining to the topic belonging to a set of first news feeds. The server computes an initial story score for each story in the first list of stories from a set of key terms scores, wherein each key term score corresponds to the number of times that the key term appears in a second list of stories pertaining to the topic belonging to a set of second news feeds. The server outputs a set of top stories from the first list of stories based on a tradeoff between the amount of overlap in key terms among the stories in the first list of stories and a combination of the initial story scores of the stories in the first list of stories.

### CROSS-REFERENCE TO RELATED APPLICATIONS

This application claims the benefit of U.S. provisional patent application No. 62/115,260 filed Feb. 12, 2015, the disclosure of which is incorporated herein by reference in its entirety.

### TECHNICAL FIELD

Examples of the present disclosure relate to a method and system to find currently relevant news stories from a plurality of news feeds and arrange them into a list of stories considered to be both newsworthy and relevant to a specified topic or set of key words, to be delivered to clients over a network.

### BACKGROUND

Generating a list of top news stories and, more particularly, identifying which news articles are “top,” or currently most relevant, is a difficult problem to solve. In addition, a user may have a few specific topics of interest when they peruse the news each day. An investor is likely to be interested in news pertaining to their holdings, while a doctor would be interested in new medical advancements. For such users, their main concern is receiving the most important news stories each day pertaining to their topics of interest.

This presents a number of obstacles which need to be overcome. Duplicate stories are likely to be present within the selection of stories in which a user is interested, especially since any given topic is only going to produce a small number of news stories on an average day unless something major happens. Thus, it is important to present the user with stories that are both relevant to their interests and significantly different from each other in topic. Additionally, the relevance of a story in each topic needs to be calculated independently for each topic, since stories which span across multiple topics may be more important to one topic than to the other topic.

### SUMMARY

The above-described problems are remedied and a technical solution is achieved in the art by providing a method find currently relevant news stories from a plurality of news feeds and arrange them into a list of stories considered to be both newsworthy and relevant to a specified topic or set of key words, to be delivered to clients over a network. In one example, a server may receive a request from a client for a list of stories pertaining to a topic. In another example, the server may initiate pushing to the client the list of stories pertaining to the topic. In an example, the server initiating pushing to the client the list of stories pertaining to the topic may be a scheduled event or triggered event.

The server may obtain a first list of stories pertaining to the topic belonging to a set of first news feeds. The server may compute an initial story score for each story in the first list of stories from a set of key term scores, wherein each key term score corresponds to the number of times that the key term appears in a second list of stories pertaining to the topic belonging to a set of second news feeds. The server may output a set of top stories from the first list of stories based on a tradeoff between the amount of overlap in key terms among the stories in the first list of stories and a combination of the initial story scores of the stories in the first list of stories.

In an example, the server outputting the set of top stories may output a story from the first list of stories having the highest initial story score into a set of top stories pertaining to the topic. In an example, for each story of the remaining stories pertaining to the topic belonging to the set of first news feeds, the server may reduce a key term score for each key term in the set of key terms of the story by a fixed positive factor when the same key term appears in the set of top stories pertaining to the topic. The server may re-compute the story score of the story based on the reduced key term score. The server may output a story having the highest positive re-computed story score into the set of top stories pertaining to the topic.

The server may repeat said reducing, said re-computing, and said outputting for the remaining stories until there are no stories having a positive story score to obtain the list of stories pertaining to the topic. In an example, a key term of a story may be associated with a plurality of terms appearing most prominently in the story. In an example, a feed may belong to a set of driver news feeds, a set of candidate news feeds, both the set of driver news feeds and the set of candidate news feeds, or neither the set of driver news feeds and the set candidate news feeds. In an example, the set of first news feeds may be a subset of the set of second news feeds. In an example, the set of first news feeds may be a set of low cost or free news feeds and the set of second news feeds may comprise a set of premium cost news feeds.

In an example, a key term score may be equal to a score corresponding to the sum of the scores of the associated terms that appear most prominently in a story. A score of a term in the set of terms that appear most prominently in a story may be incremented each time the term appears in the story.

In an example, the topic may be pre-specified.

In an example, the server may identify a list of topics in a story. In an example, the server may accept or reject each story in the first list of stories and the second list of stories based on one or more heuristic quality filters.

In an example, the server may add the accepted story to the first list of stories pertaining to the topic belonging to a set of first news feeds if the story came from one of the feeds associated with the set of first news feeds. The server may add the accepted story to the second list of stories pertaining to the topic belonging to a set of second news feeds if the story came from one of the feeds associated with the set of second news feeds.

In an example, the fixed positive factor may range between a factor permitting full overlap of key words, to a factor that does not permit any overlap of key words.

### BRIEF DESCRIPTION OF THE DRAWINGS

The present invention may be more readily understood from the detailed description of an exemplary embodiment presented below considered in conjunction with the attached drawings and in which like reference numerals refer to similar elements and in which:

FIG. 1 is a block diagram of an example system in which examples of the present disclosure may operate.

FIG. 2 is a block diagram of an example of operations performed using examples of the present disclosure.

FIG. 3 is a flow diagram illustrating an example of a method to find currently relevant news stories from a plurality of news feeds and arrange them into a list of stories considered to be both newsworthy and relevant to a specified topic or set of key words, to be delivered to clients over a network.

FIG. 4 illustrates a diagrammatic representation of a machine in the exemplary form of a computer system within which a set of instructions, for causing the machine to perform any one or more of the methodologies discussed herein, may be executed.

It is to be understood that the attached drawings are for purposes of illustrating the concepts of the invention and may not be to scale.

### DETAILED DESCRIPTION

Examples of the present disclosure provide a client with a list of stories pertaining to their topic(s) of interest. Examples of the present disclosure have a topic tracking functionality, which transmits the most relevant stories pertaining to a topic indicator, which may be, for example, a certain keyword, metadata relating to a company ticker symbol, etc. For example, an investor can obtain a news story pertaining to a company. Examples of the present disclosure send out the most relevant stories pertaining to a topic on demand. Examples of the present disclosure are also able to match stories against each other for similarity using a set of terms which feature most prominently in the story (termed cluster signature) so that the same topic for a term is not repeated in the list if there are other topics available. As used herein, the term “story signature” may refer to a short set of words or phrases, sometimes truncated or stemmed, that represent the key concepts in a story. The short set of words or phases may, in an example, comprise 5 to 15 constituents. The short set of words or phases are often made up of two different sub-signatures: A “headline signature”, which derives the short set of words or phases from headlines, and “cluster signature”, derives the short set of words or phases from the opening paragraphs of a story as a single cluster of information. As used herein, the term overlap may refer to a measure of the degree that two stories are on the same topic by looking at the overlap of components of the story signature. As used herein, the short set of words or phrases that represent the key concepts in a story may be referred to as the key terms of the story signature, headline signature, or cluster signature.

The selection of how key terms (i.e., topics) are weighed against each other is made using a set of topic-driving feeds, selected based on the comprehensiveness, depth, and general relevance of their stories. To accompany that, stories sent to the user are selected from a list of candidate feeds, or feeds to which the user has access.

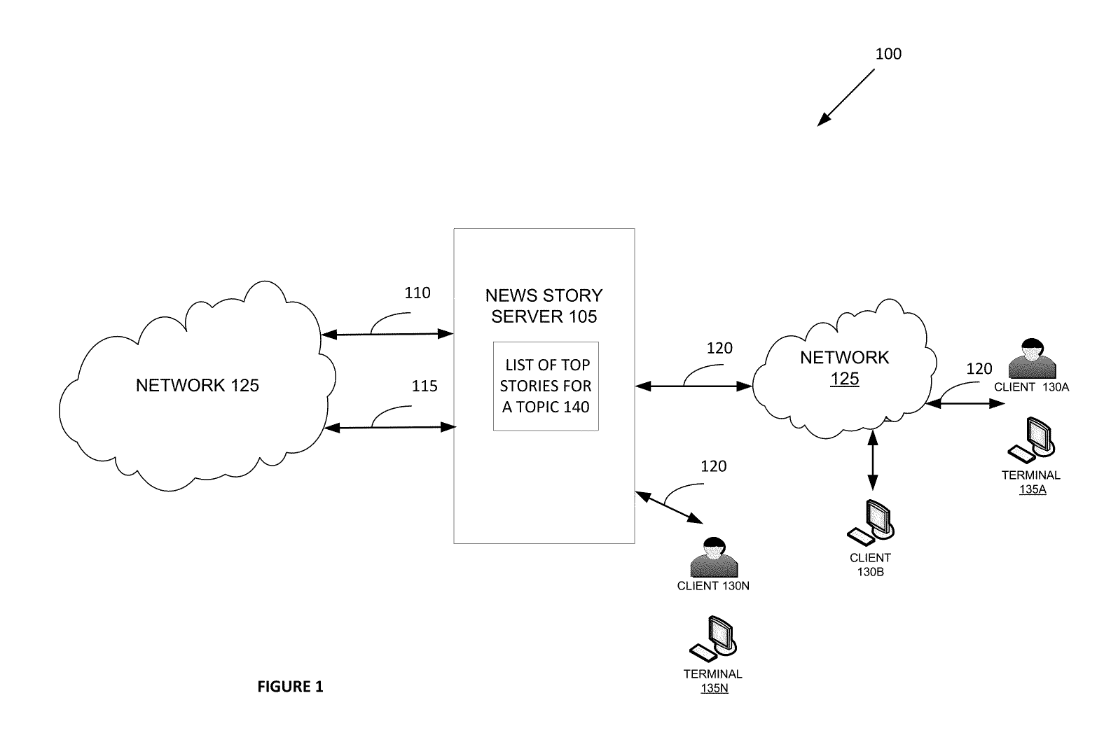

FIG. 1 is a block diagram of an example system 100 in which examples of the present disclosure may operate. A news story server 105 may be configured to receive news stories, for example, over a network 125, which may be, but is not limited to, the Internet. The news stories may be separated into two categories: lower-priced or free “candidate” feeds 110 and “topic-driving” feeds from the premium feeds 115. One or more clients 130a-130n may receive on a terminal (e.g., 135a) e.g., over the network 125 or directly from a terminal 135n communicatively connected to the news story server 105, a list of top stories for a topic 140. A client (e.g., 130a) may be, for example a human user, operator, or customer of the system 100, or may be a non-terminal automated client application (e.g., 130b) as part of a client server relationship communicatively connected to the network 125 or to the news story server 105 using an application programming interface (API). A topic could be a specific company, say IBM. The topic(s) in a given story are identified during preprocessing by the news story server 105. If a story mentions IBM, the news story server 105 considers the term IBM for the IBM topic.

A list of x top news stories for a specific topic 140 is maintained by the news story server 105 from the candidate feeds 110. The top news stories in the list of top stories for a topic 140 may be rated in relevance based on the story signature each of the top news stories in the list of top stories for a topic 140. Each individual term in the story signature may have its own score, which increases each time a news story with that term is received. However, the individual term score may decay by a small percentage each time a news story is received. The decay of term scores permits more relevant news stories to replace the older ones continuously, even when the older ones were highly relevant at the time of their release. If a story signature term is appearing in many stories over a short period of time, the term is likely to be related to a top news story. A term that appears frequently, but over a longer period of time, may still be relevant. However, it is less immediately pressing because fewer publications sent out stories with the term as soon as possible.

When a story arrives for processing by the news story server 105 from the network 125 using the topic-driving feed 110 or candidate feed 115, the story may be rejected/discarded by one or more heuristic quality filters maintained by the news story server 105. A set of heuristic filters may include, but is not limited to, the following filters listed in Table 1:

TABLE 1
The story must be in the English language.
The story must have more than 4 words in the title
The story must not have a timestamp (e.g., 11:48) in the title -- usually
indicates a non- top news story.
The story must not end with square-bracket] in the title -- publication
name in brackets usually indicates a local, non-top news story.
The story must not have any “news-in-brief” indicator words in
the title (summary, headlines, digest, top, facts, briefs, roundup,
highlights, tips, . . . ).
The story must not end with a page number (like-2-) in the title.
The story must have at least 3 cluster signature words and at least 3
headline signature words.

A story that passes the filters may be added to a list of driver stories for the topic if the story came from one of the driver feeds 115. The story may be added to a list of candidate stories for the topic if the story came from one of the candidate feeds 110. A given feed can be a driver feed, a candidate feed, or both a driver feed and a candidate feed, or neither a driver feed nor a candidate feed. (In one example, the candidate feeds may be a subset of the driver feeds.)

Separately from the flow of stories, in one example, a client (e.g., 130a) may request at any time a list of the top stories for a given topic. In another example, the server 105 may initiate pushing to one or more clients 130a-130n the list of the top stories for the given topic. The trigger for initiating pushing the list of the top stories for the given topic to the clients 130a-130n may be a scheduled event, e.g., on an hourly schedule, or a triggered event, e.g., when a new story enters the list of the top stories for the given topic. When a top-stories request is received or initiated by the news story server 105 from/to the client (e.g., 130a), the news story server 105 may take the following steps to compute the current list of top stories for a topic 140. The news story server 105 may be configured to compute an initial story score for each of the candidate stories for the topic. The story score may be the sum of the word scores of the words/terms in the story signature of the story. Initially, a word score may be the number of times that the word occurs in the story signatures of the driver stories for the topic. This is a key feature of the system 100: scores may be based on the driver stories.

The news story server 105 may be configured to compute a story score for each of the candidate stories for the topic, and output the candidate story with the highest positive score for the topic. If none are left, or the quantity of stories requested by the client (e.g., 130a) has been output, then the list of top stories for a topic 140 has been completed, and the request exits.

If the list of top stories for a topic 140 is not yet complete, then for each of the story signature words of a chosen candidate story, the news story server 105 may be configured to reduce the word score by a fixed positive factor (e.g., a percentage of 10%) of the word score. (If repeated, this can eventually cause some of the word scores to become negative.) This is a key feature of the system 100: the system 100 reduces the likelihood that another story having the same story signature words will be output. (Words that are in the topic itself—such the name of the topic company—are exempted from these reductions because they are expected to be in almost every story on the topic).

Using these adjusted word scores, the news story server 105 may be configured to return to computing a story score for each of the remaining candidate stories for the topic, outputting the highest-scoring one.

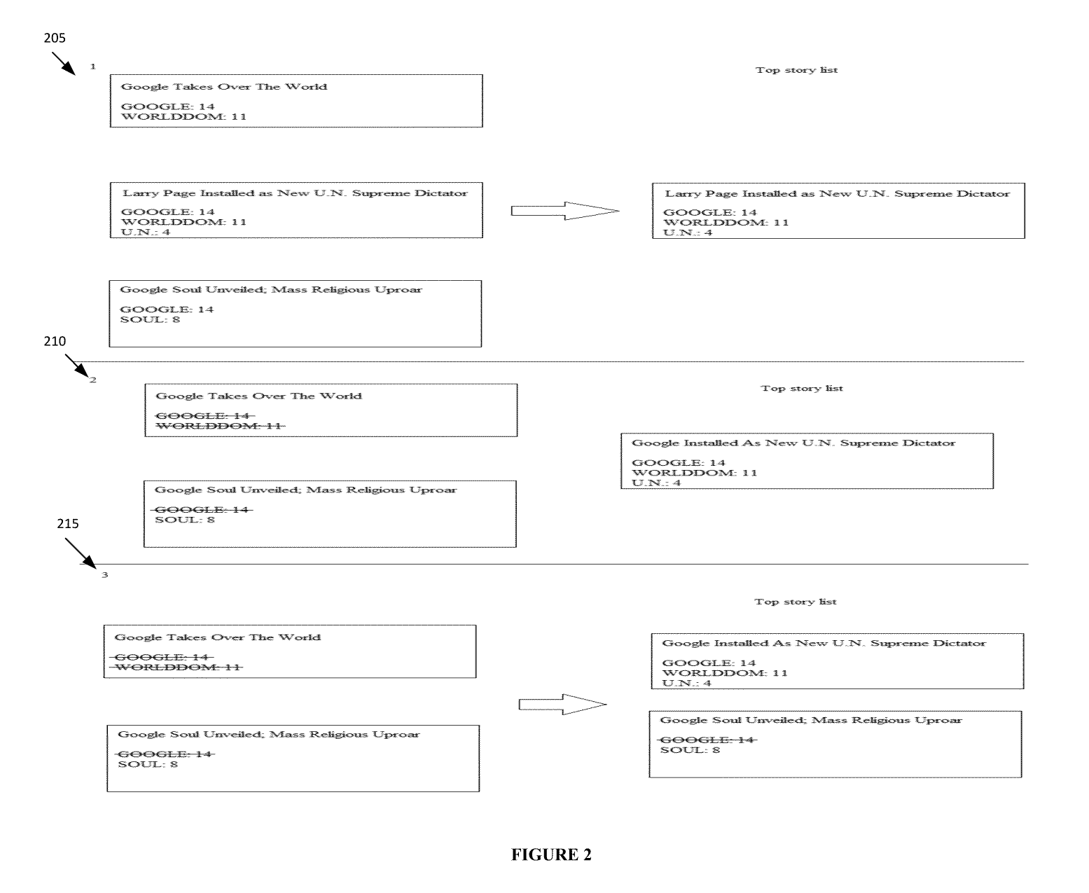

The set-building method works to pick a combination of stories that covers the most relevant news with minimal overlap. Referring to FIG. 2, at the very beginning (see block 205), the highest-scored story pertaining to a topic may be selected and added to the top set of stories for that topic 140. Afterwards, for each subsequent story in descending score order that is added to the list of top stories for a topic 140, any terms which are already represented in the top-set for a topic 140 are not counted, or are counted with a reduced score, for the story score for other stories up for consideration pertaining to that topic. For example, if the top story was about Google taking over the world, the topic term GOOGLE is excluded and the scores for terms in the story pertaining to world domination are reduced, when scoring other stories to be included in the set (see block 210). This selection method avoids including overlapping stories within the topic from being included in the list, while non-overlapping stories within the topic may be included (see block 215).

The word scores for a topic may be calculated within the set of that topic's stories to ensure that a selected story is not only relevant, but relevant to that specific topic. Google will be used again as an example, since it is quite likely that Google would have multiple large news stories in one day. If Google made a feature where Google Glass could purchase products that a user (e.g., 130a) was viewing via Amazon by having the user (e.g., 130a) wink three times at the product, the GLASSES keyword would become very high-scoring in the set of stories pertaining to Google and Amazon. Later in the day, among other news, Disney unveils a new line of kids glasses themed around their most recent protagonists. The GLASSES keyword under Disney would not automatically propel that story to a top status, because the score for GLASSES within the Disney topic and within the Google topic are separate scores. This way, embodiments of the present disclosure deliver news to the client (e.g., 130a) which is relevant specifically to the topics that the client (e.g., 130a) chooses.

The system 100 also provides that, even if two stories do have an overlap, they can both be included in the list of top stories for a topic 140 sent to the client (e.g., 130a) if their stories signatures indicate that the stories differ sufficiently from each other. For example, a storm-chasing user (e.g., 130a) may want to track the term TORNADO. However, articles containing the term TORNADO are likely to have a few terms in common with each other besides TORNADO itself, such as DISASTER. In this eventuality, the system 100 can recognize that two stories are covering different tornadoes by tallying up the other story signature terms which have not yet been removed. Thus, if one tornado occurred in the United States, a story about a tornado in South Africa can still make it through because the United States article does not eliminate the story signature terms relating to locations in South Africa, just the terms relating to tornadoes in general.

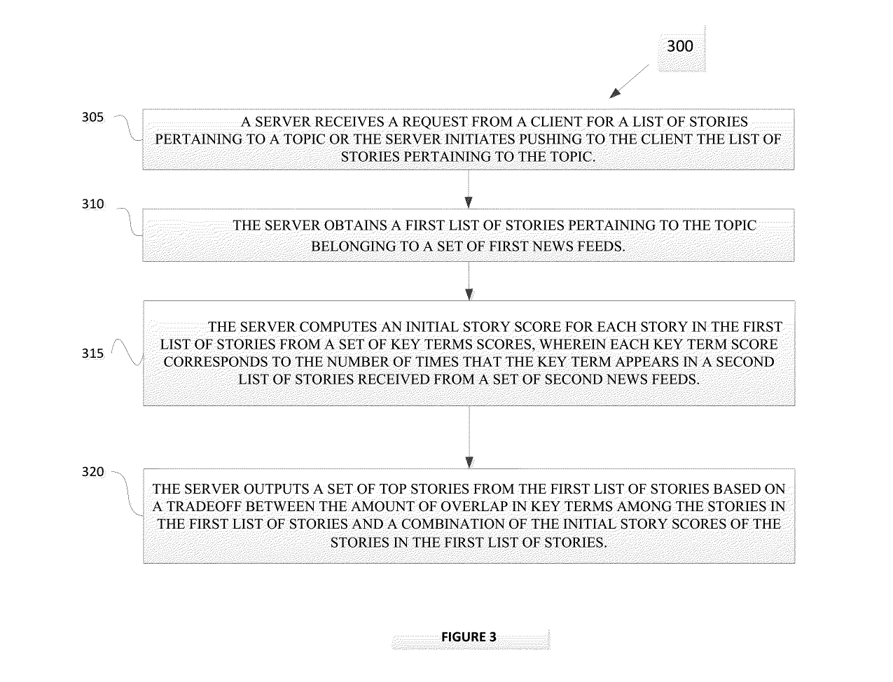

FIG. 3 is a flow diagram illustrating an example of a method 300 to find currently relevant news stories from a plurality of news feeds and arrange them into a list of stories 140 considered to be both newsworthy and relevant to a specified topic or set of key words, to be delivered to clients 130a-130n over a network 125. The method 300 may be performed by at least one processor of the server 105 of FIG. 1 and may comprise hardware (e.g., circuitry, dedicated logic, programmable logic, microcode, etc.), software (e.g., instructions run on a processing device), or a combination thereof. In one example, the method 300 may be performed by processing logic 422 of the processor of the server 105 of FIG. 1.

As shown in FIG. 3, at block 305, the server 105 may receive a request from a client (e.g., 130a) for a list of stories pertaining to a topic or the server 105 may initiate pushing to the client (e.g., 130a) the list of stories pertaining to the topic. The trigger for initiating pushing the list of the top stories for the given topic to the client (e.g., 130a) may be a scheduled event, e.g., on an hourly schedule, or a triggered event, e.g., when a new story enters the list of the top stories for the given topic. In an example, the topic may be pre-specified. In an example, prior to receiving the request for a list of stories pertaining to the topic, the server 105 may identify a list of topics in a story.

At block 310, the server 105 may obtain a first list of stories pertaining to the topic belonging to a set of first news feeds 110 (e.g., over a network 125, e.g., the Internet). In an example, the set of first news feeds 110 may be a set of candidate news feeds, e.g., a set of low cost or free news feeds. At block 315, the server 105 may compute an initial story score for each story in the first list of stories from a set of key terms scores (e.g., term scores of corresponding story signatures). Each key term score may correspond to the number of times that the key term appears in a second list of stories received from a set of second news feeds 115. In an example, the set of second news feeds 115 may be a set of driver news feeds, e.g., a set of premium cost news feeds. In an example, the set of first news feeds may be a subset of the set of second news feeds. In an example, wherein a score of a term in the set of terms that appear most prominently in a story is incremented each time the term appears in the story.

In an example, a key term of a story may be associated with a plurality of terms appearing most prominently in the story. In an example, the set of second news feeds 115 may be a set of premium cost news feeds. In an example, a feed may belong to the set of driver news feeds, the set of candidate news feeds, both the set of driver feeds and the set of candidate news feeds, or neither the set of driver news feeds and the set of candidate news feeds. In an example, the set of first news feeds may be a subset of the set of second news feeds 115.

In an example, a key term score may be equal to a score corresponding to the sum of the scores of the associated terms that appear most prominently in a story. In an example, a score of a term in the set of terms that appear most prominently in a story may be incremented each time the term appears in the story.

In an example, prior to outputting the list of stories pertaining to the topic, the server 105 may accept or reject each story in the first list of stories and the second list of stories based on one or more heuristic quality filters. In an example, the server 105 may add the accepted story to the first list of stories pertaining to the topic belonging to a set of first news feeds if the story came from one of the feeds associated with the set of first news feeds 110. In an example, the server 105 may add the accepted story to the second list of stories pertaining to the topic belonging to a set of second news feeds if the story came from one of the feeds associated with the set of second news feeds 115.

At block 320, the server 105 may output a set of top stories from the first list of stories based on a tradeoff between the amount of overlap in key terms among the stories in the first list of stories and a combination of the initial story scores of the stories in the first list of stories.

In an example, the server 105, outputting the set of top stories comprises outputting, by the server, a story from the first list of stories having the highest initial story score into a set of top stories pertaining to the topic. In an example, for each story of the remaining stories pertaining to the topic belonging to the set of first news feeds, the server 105 may reduce a key term score for each key term in the set of key terms of the story by a fixed positive factor when the same key term appears in the set of top stories pertaining to the topic. The server 105 may re-compute the story score of the story based on the reduced key term score. The server 105 may output a story having the highest positive re-computed story score into the set of top stories pertaining to the topic. The server 105 may repeat said reducing, said re-computing, and said outputting for the remaining stories until there are no stories having a positive story score to obtain the list of stories pertaining to the topic In an example, the fixed positive factor may range between a factor permitting full overlap of key words, to a factor that does not permit any overlap of key words.

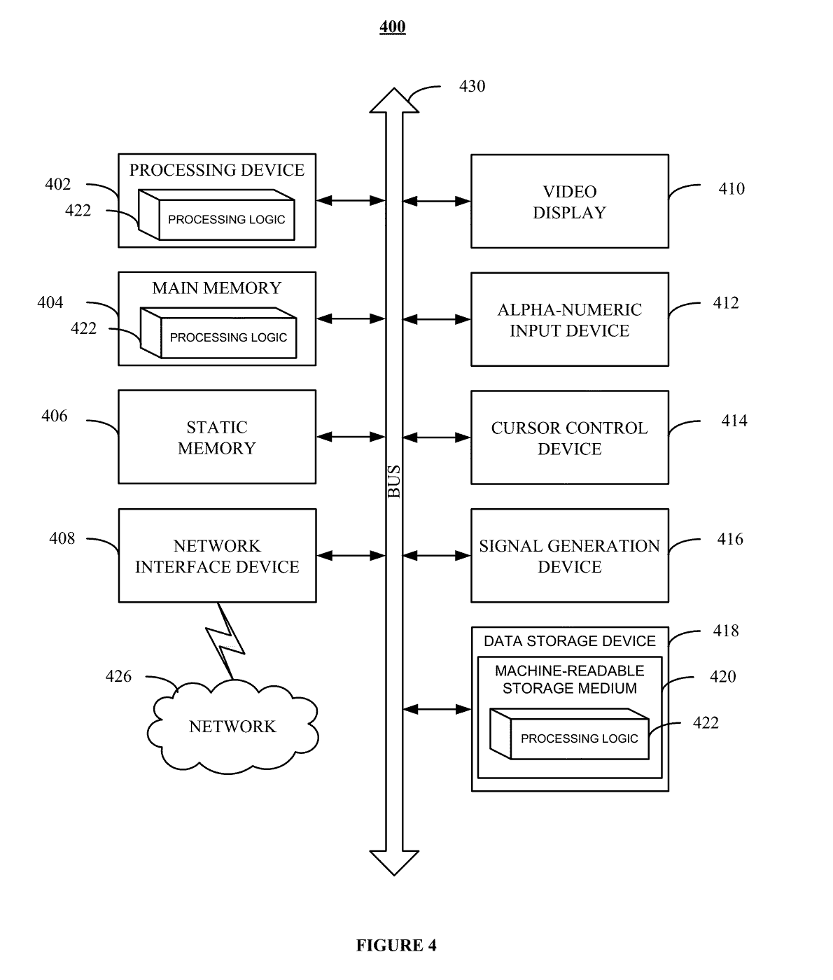

FIG. 4 illustrates a diagrammatic representation of a machine in the exemplary form of a computer system 400 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 400 includes a processing device 402, a main memory 404 (e.g., read-only memory (ROM), flash memory, dynamic random access memory (DRAM) (such as synchronous DRAM (SDRAM) or Rambus DRAM (RDRAM), etc.), a static memory 406 (e.g., flash memory, static random access memory (SRAM), etc.), and a data storage device 418, which communicate with each other via a bus 430.

Processing device 402 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 402 may also be one or more special-purpose processing devices such as an application specific integrated circuit (ASIC), a field programmable gate array (FPGA), a digital signal processor (DSP), network processor, or the like. Processing device 402 is configured to execute processing logic 422 for performing the operations and steps discussed herein.

Computer system 400 may further include a network interface device 408. Computer system 400 also may include a video display unit 410 (e.g., a liquid crystal display (LCD) or a cathode ray tube (CRT)), an alphanumeric input device 412 (e.g., a keyboard), a cursor control device 414 (e.g., a mouse), and a signal generation device 416 (e.g., a speaker).

Data storage device 418 may include a machine-readable storage medium (or more specifically a computer-readable storage medium) 420 having one or more sets of instructions embodying any one or more of the methodologies of functions described herein. Device logic of may also reside, completely or at least partially, within main memory 404 and/or within processing device 402 during execution thereof by computer system 400; main memory 404 and processing device 402 also constituting machine-readable storage media. Processing logic 422 may further be transmitted or received over a network 426 via network interface device 408.

Machine-readable storage medium 420 may also be used to store the processing logic 422 persistently. While machine-readable storage medium 420 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instruction for execution by the machine and that causes the machine to perform any one or more of the methodologies of the present invention. The term “machine-readable storage medium” shall accordingly be taken to include, but not be limited to, solid-state memories, and optical and magnetic media.

The components and other features described herein can be implemented as discrete hardware components or integrated in the functionality of hardware components such as ASICs, FPGAs, DSPs or similar devices. In addition, these components can be implemented as firmware or functional circuitry within hardware devices. Further, these components can be implemented in any combination of hardware devices and software components.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the above discussion, it is appreciated that throughout the description, discussions utilizing terms such as “enabling”, “transmitting”, “requesting”, “identifying”, “querying”, “retrieving”, “forwarding”, “determining”, “passing”, “processing”, “disabling”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions, each of which may be coupled to a computer system bus.

The algorithms and displays presented herein are not inherently related to any particular computer or other apparatus. Various general purpose systems may be used with programs in accordance with the teachings herein or it may prove convenient to construct more specialized apparatus to perform the required method steps. The required structure for a variety of these systems will be apparent from the description above. In addition, the present invention is not described with reference to any particular programming language. It will be appreciated that a variety of programming languages may be used to implement the teachings of the invention as described herein.

It is to be understood that the above description is intended to be illustrative, and not restrictive. Many other examples will be apparent to those of skill in the art upon reading and understanding the above description. The scope of the disclosure should, therefore, be determined with reference to the appended claims, along with the full scope of equivalents to which such claims are entitled.

1. A method, comprising:
obtaining, by a server, a first list of stories pertaining to a topic belonging to a set of first news feeds;
computing, by the server, an initial story score for each story in the first list of stories from a set of key terms scores, wherein each key term score is based on the number of times that the key term appears in a second list of stories pertaining to the topic belonging to a set of second news feeds; and
outputting, by the server, a set of top stories from the first list of stories based on a tradeoff between the amount of overlap in key terms among the stories in the first list of stories and key terms among the stories in the second list of stories in view of the initial story scores of the stories in the second list of stories,
wherein a first story from the first list of stories is included in the set of top stories when the degree of overlap between the key terms in the first story and the key terms in a second story is above a threshold, and
wherein the first story is outputted based on the similarity of the first story to the second story against which the first story is measured.

2. The method of claim 1, further comprising receiving, by the server from a client, a request for the list of stories pertaining to the topic.

3. The method of claim 1, further comprising initiating pushing, by the server to a client, the list of stories pertaining to the topic.

4. The method of claim 3, wherein initiating pushing to the client the list of stories pertaining to the topic is a scheduled event or triggered event.

5. The method of claim 1, wherein outputting the set of top stories comprises outputting, by the server, a story from the first list of stories having the highest initial story score into a set of top stories pertaining to the topic.

6. The method of claim 5, further comprising, for each story of the remaining stories pertaining to the topic belonging to the set of first news feeds:
reducing, by the server, a key term score for each key term in the set of key terms of the story by a fixed positive factor when the same key term appears in the set of top stories pertaining to the topic; and
re-computing, by the server, the story score of the story based on the reduced key term score; and
repeating said reducing, said re-computing, and said outputting for the remaining stories until there are no stories having a positive story score to obtain the list of stories pertaining to the topic.

7. The method of claim 6, further comprising, outputting, by the server, a story having the highest positive re-computed story score into the set of top stories pertaining to the topic.

8. The method of claim 1, wherein a key term of a story is associated with a plurality of terms appearing most prominently in the story.

9. The method of claim 1, wherein the set of first news feeds is a set of low cost or free news feeds and the set of second news feeds comprises a set of premium cost news feeds.

10. (canceled)

11. (canceled)

12. The method of claim 1, wherein a key term score is equal to a score corresponding to scores of the sum of the terms that appear most prominently in a story.

13. The method of claim 1, wherein a score of a term in the set of terms that appear most prominently in a story is incremented each time the term appears in the story.

14. The method of claim 1, wherein the topic is pre-specified.

15. The method of claim 1, further comprising identifying, by the server, a list of topics in a story.

16. The method of claim 1, further comprising
accepting or rejecting, by the server, each story in the first list of stories and the second list of stories based on one or more heuristic quality filters.

17. The method of claim 16, further comprising:
adding the accepted story to the first list of stories pertaining to the topic belonging to a set of first news feeds if the story came from one of the feeds associated with the set of first news feeds.

18. (canceled)

19. The method of claim 1, wherein the fixed positive factor ranges between a factor permitting full overlap of key words, to a factor that does not permit any overlap of key words.

20. A system, comprising:
a memory;
a server, coupled to the memory, the server to:
obtain a first list of stories pertaining to a topic belonging to a set of first news feeds;
compute an initial story score for each story in the first list of stories from a set of key terms scores, wherein each key term score is based on the number of times that the key term appears in a second list of stories pertaining to the topic belonging to a set of second news feeds; and
output a set of top stories from the first list of stories based on a tradeoff between the amount of overlap in key terms among the stories in the first list of stories and key terms among the stories in the second list of stories in view of the initial story scores of the stories in the second list of stories,
wherein a first story from the first list of stories is included in the set of top stories when the degree of overlap between the key terms in the first story and the key terms in a second story is above a threshold, and
wherein the first story is outputted based on the similarity of the first story to the second story against which the first story is measured.

21. The system of claim 20, wherein the server is further to receive from a client a request for the list of stories pertaining to the topic.

22. The system of claim 20, wherein the server is further to initiate pushing to a client the list of stories pertaining to the topic.

23. The system of claim 20, wherein the server outputting the set of top stories comprises the server to, for each story of the remaining stories pertaining to the topic belonging to the set of first news feeds:
reduce a key term score for each key term in the set of key terms of the story by a fixed positive factor when the same key term appears in the set of top stories pertaining to the topic; and
re-compute the story score of the story based on the reduced key term score; and
repeat said reducing, said re-computing, and said outputting for the remaining stories until there are no stories having a positive story score to obtain the list of stories pertaining to the topic.

24. The system of claim 23, wherein the server is further to output a story having the highest positive re-computed story score into the set of top stories pertaining to the topic.

25. A non-transitory computer readable storage medium including instructions that, when executed by a server, cause the server to:
obtain, by the server, a first list of stories pertaining to a topic belonging to a set of first news feeds;
computer, by the server, an initial story score for each story in the first list of stories from a set of key terms scores, wherein each key term score is based on the number of times that the key term appears in a second list of stories pertaining to the topic belonging to a set of second news feeds; and
output, by the server, a set of top stories from the first list of stories based on a tradeoff between the amount of overlap in key terms among the stories in the first list of stories and key terms among the stories in the second list of stories in view of the initial story scores of the stories in the second list of stories,
wherein a first story from the first list of stories is included in the set of top stories when the degree of overlap between the key terms in the first story and the key terms in a second story is above a threshold, and
wherein the first story is outputted based on the similarity of the first story to the second story against which the first story is measured.

26. The non-transitory computer readable storage medium of claim 25, wherein the server is further to receive, from a client, a request for the list of stories pertaining to the topic.

27. The non-transitory computer readable storage medium of claim 25, wherein the server is further to initiate pushing, to a client, the list of stories pertaining to the topic.

28. The non-transitory computer readable storage medium of claim 25, wherein outputting the set of top stories comprises the server to output a story from the first list of stories having the highest initial story score into a set of top stories pertaining to the topic.

29. The non-transitory computer readable storage medium of claim 25, wherein the server is further to, for each story of the remaining stories pertaining to the topic belonging to the set of first news feeds:
reduce a key term score for each key term in the set of key terms of the story by a fixed positive factor when the same key term appears in the set of top stories pertaining to the topic; and
re-compute the story score of the story based on the reduced key term score; and
repeat said reducing, said re-computing, and said outputting for the remaining stories until there are no stories having a positive story score to obtain the list of stories pertaining to the topic.

30. The non-transitory computer readable storage medium of claim 29, wherein the server is further to output a story having the highest positive re-computed story score into the set of top stories pertaining to the topic.
